(19) United States
(12) Patent Application Publication
(10) Pub. No.: US 2025/0094862 A1
(43) Pub. Date: Mar. 20, 2025

(54) FAIRNESS FEATURE IMPORTANCE: UNDERSTANDING AND MITIGATING UNJUSTIFIABLE BIAS IN MACHINE LEARNING MODELS

(71) Applicant: Oracle International Corporation, Redwood Shores, CA (US)

(72) Inventors: Yasha Pushak, Vancouver (CA); Mathieu Godbout, Stoneham-et-Tewkesbury (CA); Hesam Fathi Moghadam, Sunnyvale, CA (US); Sungpack Hong, Palo Alto, CA (US); Hassan Chafi, San Mateo, CA (US)

(21) Appl. No.: 18/529,182

(22) Filed: Dec. 5, 2023

Related U.S. Application Data
(60) Provisional application No. 63/538,441, filed on Sep. 14, 2023.

(51) Int. Cl. G06N 20/00

(52) U.S. Cl. CPC G06N 20/00

(57) ABSTRACT

In an embodiment, a computer generates a respective original inference from each of many records. Permuted values are selected for a feature from original values of the feature. Based on the permuted values for the feature, a permuted inference is generated from each record. Fairness and accuracy of the original and permuted inferences are measured. For each of many features, the computer measures a respective impact on fairness of a machine learning model, and a respective impact on accuracy of the machine learning model. A global explanation of the machine learning model is generated and presented based on, for multiple features, the impacts on fairness and accuracy. Based on the global explanation, an interactive indication to exclude or include a particular feature is received. The machine learning model is (re-)trained based on the interactive indication to exclude or include the particular feature, which may increase the fairness of the model.

### CROSS-REFERENCE TO RELATED APPLICATION; BENEFIT CLAIM

This application claims the benefit of Provisional Application 63/538,441, filed Sep. 14, 2023, the entire contents of which are hereby incorporated by reference as if fully set forth herein, under 35 U.S.C. § 119(e).

### FIELD OF THE INVENTION

The present invention relates to feature selection that increases fairness of a machine learning (ML) model. Herein is fairness impact measurement for a sensitive feature that can be permuted.

### BACKGROUND

Machine learning (ML) models can often be used in applications where their decisions will directly impact people. In these sensitive applications, one must be careful so that the ML models' automated decisions do not disproportionately affect different subgroups of a population. For example, a selection tool should not systematically favor one kind of candidates. While methods have been proposed to mitigate unintended bias present in machine learning models, it remains challenging to train an ML model that satisfies high levels of fairness and accuracy at the same time.

Justifiable model bias may occur when a model learns to use a logically sound feature to predict an outcome, even if that feature is correlated with a protected attribute. A machine learning algorithm that is proactively searching online professional profiles to find potential candidates for a skilled position should not overlook a qualified candidate merely due to an incidental attribute such as zip code that may be correlated with a protected attribute, even if the incidental attribute is negatively correlated with a qualification attribute such as education. Conversely, it is justifiable for the machine learning algorithm to rank candidates based on whether they have a needed credential.

Various bias mitigation algorithms exist to improve fairness metric scores of machine learning models. These generally fall into one of three mutually-exclusive categories:
1. Pre-processing algorithms, which seek to remove protected information from a dataset so that a machine learning trained on the modified dataset are likely to have better scores on fairness metrics. For example, correlation removal will remove the pairwise correlation between training features and a protected attribute. Fair representation learning will learn a latent encoding of the data that obfuscates information about the protected attributes.
2. In-processing algorithms, which are (adaptions of existing) machine learning algorithms that train models while taking fairness metrics into account in addition to optimizing for accuracy.
3. Post-processing algorithms, which take machine learning models that have already been trained and modify their predictions to improve their scores on fairness metrics. For example, calibrated equality of opportunity randomly selects between learned prediction probability thresholds to produce models with calibrated prediction probabilities and better fairness metric scores. Reject option classifier learns to give favorable outcomes to unprivileged groups and unfavorable outcomes to privileged groups by modifying predictions near to the model's decision boundary. Multiplier tuning learns to modify prediction probabilities to obtain a near-optimal tradeoff between fairness metric scores and accuracy.

However, none of those methods are capable of distinguishing between justifiable model bias and unfair model bias. As a result, these algorithms may wrongly remove justifiable model bias, thereby unnecessarily decreasing model accuracy. By detecting and retaining justifiable model bias, the approach herein increases model accuracy beyond the state of the art.

### BRIEF DESCRIPTION OF THE DRAWINGS

In the drawings:

FIG. 1 is a block diagram that depicts an example computer that, based on fairness impact measurement for a sensitive feature that can be permuted, interactively selects some features to increase fairness of a machine learning (ML) model;

FIG. 2 depicts an example bar chart that may be part of a global explanation of an ML model.

FIG. 3 is a flow diagram that depicts an example computer process that, based on fairness impact measurement for a sensitive feature that can be permuted, interactively selects some features to increase fairness of an ML model;

FIG. 4 depicts an example scatterplot that may be part of a global explanation of an ML model.

FIG. 5 is a flow diagram that depicts an example computer process that, based on fairness impact measurement for a sensitive feature that can be permuted, generates and presents a global explanation that facilitates interactive selection of some features to increases fairness of an ML model;

FIG. 6 is a block diagram that illustrates a computer system upon which an embodiment of the invention may be implemented;

FIG. 7 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Here is interactive feature selection that increases fairness of a machine learning (ML) model based on fairness impact measurement for a sensitive feature that can be permuted. This is an innovative approach for attributing bias in a trained machine learning model to individual features that the model uses for predictions. This allows a user to analyze the extent to which a model's bias is justifiable (i.e. fair) or unjustifiable. Explanations generated herein may be used to remove unjustifiable bias from a machine learning model. Herein is a novel method for visualizing information that can help users decide the extent to which a feature's impact on a model's bias score should be considered justifiable. This allows users to more quickly and more accurately identify a justifiable set of features for model training, thereby mitigating unjustifiable model bias.

Herein are two kinds of feature importance, and both kinds may have separate importance scores. Inference feature importance indicates how influential is a feature on a model's inferencing. Inference feature importance also is referred to herein as accuracy feature importance. Fairness feature importance is how influential is a feature on a model's fairness metric score. Feature importance may be referred to herein as feature impact.

Unlike techniques that measure inference feature importance, this technique measures fairness feature importance. Instead of calculating the score of the model using an accuracy metric (for example, F1 score for classification, R2 score for regression), a fairness/bias score metric (for example, statistical parity or equalized odds) is used. However, fairness metrics require more information than accuracy metrics to be calculated. In addition to the model's predictions, fairness metrics also require the value(s) of the protected attribute(s) for each row in a dataset. Depending on the scenario, these protected attributes may or may not be training features of the model. For example, a feature vector may exclude none, some, or all protected attribute(s), such as gender.

If a protected feature is a training feature (i.e. included in a feature vector), an exact copy of the feature is made to compute the fairness scores. Otherwise, when the protected attribute is a feature that is shuffled, the fairness score would be computed incorrectly. This special copying increases fidelity of the explanations. In other words, approaches herein work well even if a protected attribute is permuted during feature importance measurement. Herein, protected and sensitive may be synonyms.

This approach has at least the following innovations. Permutation feature impact is based on any of various fairness metrics. Fairness and accuracy feature impacts are displayed as a scatterplot to highlight tradeoffs between how features contribute to fairness metric scores and accuracy. This approach guides users to distinguish justified and unjustified features based on plot quadrants of measurements. Fairness feature impact is used to iteratively remove features that unjustifiably increase bias metric scores until a model with a better bias metric score can be found.

This approach has at least the following advantages. It is straightforward to implement, which makes it less prone to implementation errors than existing solutions. It runs in linear time, which is faster than Shapley-based feature importance algorithms that are either exponential or require approximations that decrease quality. This approach returns a collection of models for the user to pick from, which allows the user to have the final say in what is the fairness-accuracy tradeoff they prefer for their application. This approach is versatile and can be applied to any machine learning model that expects a tabular dataset (e.g. spreadsheet or database table). For example, each row may be encoded into a respective feature vector. This approach is deterministic at inference time. Unlike many existing bias mitigation postprocessing procedures, bias mitigation herein is a preprocessing algorithm and will always return exactly the same prediction for a given test example, because this approach does not rely upon random sampling to alter the predictions. This approach returns interpretable probabilities. Postprocessing bias mitigation methods directly modify predictions without adjusting prediction probabilities, which means that the original model prediction probabilities can no longer be interpreted normally. Postprocessing succumbs to various problems such as a label that has a prediction probability of 0.99 may, by postprocessing, not end up being the predicted label, which is counterintuitive and may seem difficult to explain how or why post processing would, for example, reverse (i.e. flip) a binary classification. This also means that any method of scoring the accuracy of a model that relies on prediction probabilities (e.g., log loss, AUC ROC) cannot be used with postprocessing methods. The approach herein instead is a preprocessing algorithm, which precedes model retraining.

In an embodiment, a computer measures, for each of many features, a respective impact on fairness of a machine learning model, and a respective impact on accuracy of the machine learning model. A global explanation of a machine learning model is generated and presented based on, for multiple features, the impacts on fairness and accuracy. Based on the global explanation, an interactive indication to exclude or include a particular feature is received. The machine learning model is (re-)trained based on the interactive indication to exclude or include the particular feature.

In an embodiment, a computer generates a respective original inference from each of many records. Permuted values are selected for a feature from original values of the feature. Based on the permuted values for the feature, a permuted inference is generated from each record. Fairness and accuracy of the original and permuted inferences are measured. A machine learning model is trained with the records excluding, based on a difference between the fairness of the original inferences and the fairness of the permuted inferences, the feature.

### 1.0 Example Computer

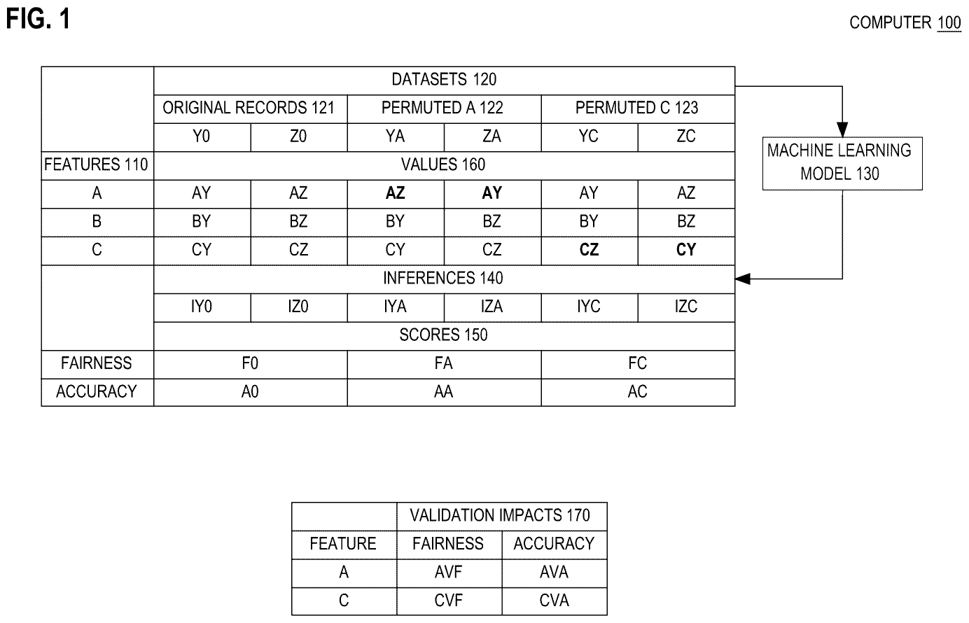

FIG. 1 is a block diagram that depicts an example computer 100, in an embodiment. Computer 100 may be one or more of a rack server such as a blade, a mainframe, a personal computer, or a virtual machine.

Based on fairness impact measurement for sensitive feature A that can be permuted, computer 100 interactively selects some of features A-C to increase fairness of machine learning (ML) model 130. ML model 130 has a validation corpus that contains original records 121 that are individual original inputs Y0-Z0. Herein a record is also referred to as an input.

ML model 130 individually accepts any of inputs Y0-Z0, YA-ZA, and YC-ZC, which causes ML model 130 to generate (i.e. infer, predict) a respective one of inferences IY0-IZ0, IYA-IZA, and IYC-IZC. In other words, ML model 130 infers inferences 140 from inputs 120, and each column in data structures 120, 140, and 160 corresponds to a respective individual input and inference.

### 1.1 Sensitive Feature and Protected Groups

As shown in values 160, each input contains a respective value for each of features A-C in features 110. For example, original input Y0 has values AY-CY respectively for features A-C. Likewise, feature A has values AY-AZ respectively in original inputs Y0-Z0.

One or some of features A-C may be a sensitive feature that deserves special consideration because it identifies a protected group. In an embodiment, each of inputs Y0-Z0, YA-ZA, and YC-ZC is a feature vector, such as a one-dimensional array of numbers, that represents a record of a subject such as a person. Each of features A-C has a respective datatype such as a number, a string, or a data structure, and all of those datatypes can be numerically encoded in a feature vector such as by one-hot encoding or hash encoding.

Herein, each distinct value of a sensitive feature or each distinct disjoint (i.e. nonoverlapping) subset of values of the sensitive feature is referred to as a protected group. Herein, there always are multiple protected groups of the sensitive feature.

### 1.2 Feature Permutation

Each of permuted datasets 122-123 is a generated permutation of the original dataset that is original records 121, and collectively these are datasets 121-123. Each of permuted datasets 122-123 has a respective distinct exactly one of features A-C permuted. Feature A is permuted in dataset permuted A 122, and feature C is permuted in dataset permuted C 123.

Permutation herein means that: a) some or all of original inputs Y0-Z0 are imperfectly copied to generate permuted inputs; and b) the values of exactly one feature are randomly shuffled to generate permuted inputs that might not exist in original records 121. For example, permuted inputs YA-ZA are contained in dataset 122 but not 121. Permuted values are shown bold in values 160.

For example, permuted input YA is an imperfect copy of original input Y0, and inputs Y0 and YA both have values BY-CY for respective features B-C. Because feature A is permuted in dataset permuted A 122, inputs Y0 and YA have different respective values AY and AZ for permuted feature A. Permuted value AZ in permuted input YA was obtained (e.g. copied) from randomly selected original input Z0. In other words, permuted input YA is an imperfect copy of original input Y0 and also is a hybrid of exactly two original inputs Y0-Z0.

### 1.3 Fairness Measurement

ML model 130 individually validates datasets 121-123 to generate validation scores 150 that are numbers. For example, validation of original records 121 generates validation scores A0 and F0 that respectively measure accuracy and fairness of ML model 130 for original records 121. Fairness score F0 is based on all of inferences IY0-IZ0 that were generated from original records 121. Likewise, accuracy score A0 is based on all of inferences IY0-IZ0 too.

Herein, validation and scores 150 are supervised as follows. Accuracy is supervised measured based on comparing (e.g. measuring differences) between inferences from a dataset and known correct labels. In other words, original records 121 is a labeled validation corpus, and each of original inputs Y0-Z0 has a respective label that can be compared to respective inferences IY0-IZ0 to measure accuracy A0.

Fairness is self-supervised measured based on values of a sensitive feature in the inputs of the dataset and based on inferences from the dataset. In those respective distinct ways, fairness and accuracy are both based on inferences from the dataset.

None, one, or both of fairness and accuracy may be based on confusion matrix(s). Each confusion matrix may be based on one, some, or all values of the sensitive feature in the dataset. For example, accuracy may be based on a single confusion matrix that is based on all of inferences IY0-IZ0, and fairness may be based on a respective separate confusion matrix for each protected group of a sensitive feature in the dataset.

If ML model 130 is a classifier, an embodiment may use any of the following classification fairness metrics: Statistical Parity Difference (SPD), Disparate Impact (DI), Equal Opportunity Difference (EOD), Equalized Odds Difference (EOD), Demographic Parity (DP), Conditional Demographic Disparity (CDD), Theil's Information Inequality, Confusion Matrix Disparity (CMD), Consistency Score, and Treatment Equality (TE).

If ML model 130 instead is a regression, an embodiment may use any of the following regression fairness metrics: Prediction Parity, Mean Absolute Error (MAE) Disparity, Mean Squared Error (MSE) Disparity, Relative Mean Absolute Error (RMAE) Disparity, Relative Mean Squared Error (RMSE) Disparity, Symmetric Mean Absolute Percentage Error (sMAPE) Disparity, and R-Squared Disparity.

### 1.4 Impact of Feature on Fairness

Permutation confuses ML model 130. Thus, permutation decreases accuracy of permuted inferences IYA-IZA and IYC-IZC, and unpermuted original accuracy A0 is higher (i.e. better) than most or all of permuted accuracies AA and AC.

Permutation also confuses correlations between features 110 and sensitive feature(s) and correlations between features 110 and the labels of original records 121. Thus, permutation decreases learned bias of ML model 130, which can increase fairness of permuted inferences IYA-IZA and IYC-IZC.

Herein, validation impact is a signed numeric measurement of a change of a validation score after a permutation of one feature. For example in dataset permuted A 122, feature A is permuted. In that case in validation impacts 170, fairness impact AVF of feature A is a difference between fairness scores F0 and FA. Likewise, accuracy impact AVC of feature C is a difference between accuracy scores A0 and AC. In that way, each permuted feature has: a) a respective permuted dataset and b) signed numeric measurements respectively of fairness impact and accuracy impact.

Feature selection based on novel validation impacts 170 is discussed later herein. In an embodiment, fairness impact is instead measured as bias impact, in which case lower is better because fairness and bias are inversely correlated. Fairness is desirable and bias is undesirable, but the underlying phenomenon is the same; only the perspective of measurement is different.

### 2.0 Example Global Explanation with Bar Chart

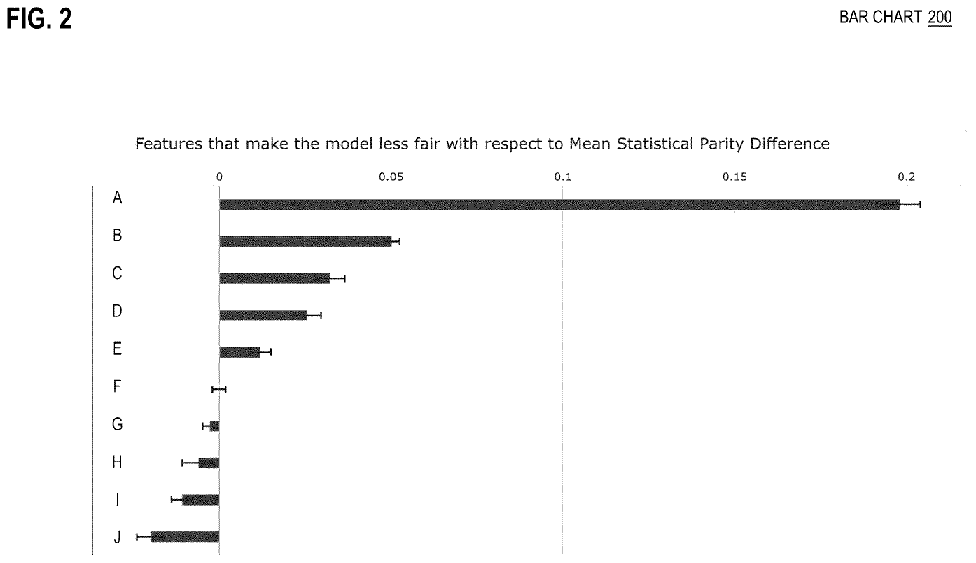

FIG. 2 depicts an example bar chart 200 that computer 100 may generate and send or display, in an embodiment. In an embodiment, bar chart 200 is part of a global explanation of ML model 130 that computer 100 generates and sends or displays.

Bar chart 200 shows that fairness of ML model 130 depends on features A-J that may or may not include features A-C in FIG. 1. In other words, feature A may or may not be a different feature in each of FIGS. 1-2. The vertical (i.e. independent) axis of bar chart 200 has features A-J. The horizontal (i.e. dependent) axis is fairness impact measured as bias impact, where lower is better as discussed earlier herein.

Bar chart 200 shows a respective horizontal bar for each of features A-J. The length of a bar indicates the magnitude of fairness impact. The direction (i.e. leftwards or rightwards) respectively indicates a negative or positive impact on bias. For example, the shown positive bias impact of feature A conversely decreases fairness, and FIG. 2 says “less fair”. As shown, features A-E variously decrease fairness (i.e. increase bias); feature F is neutral (i.e. has no fairness impact); and features G-J variously increase fairness. As discussed later herein, feature selection may partly depend on fairness impact or on bar chart 200. In an embodiment, the horizontal axis instead is accuracy impact.

### 3.0 First Example Interactive Feature Selection Process

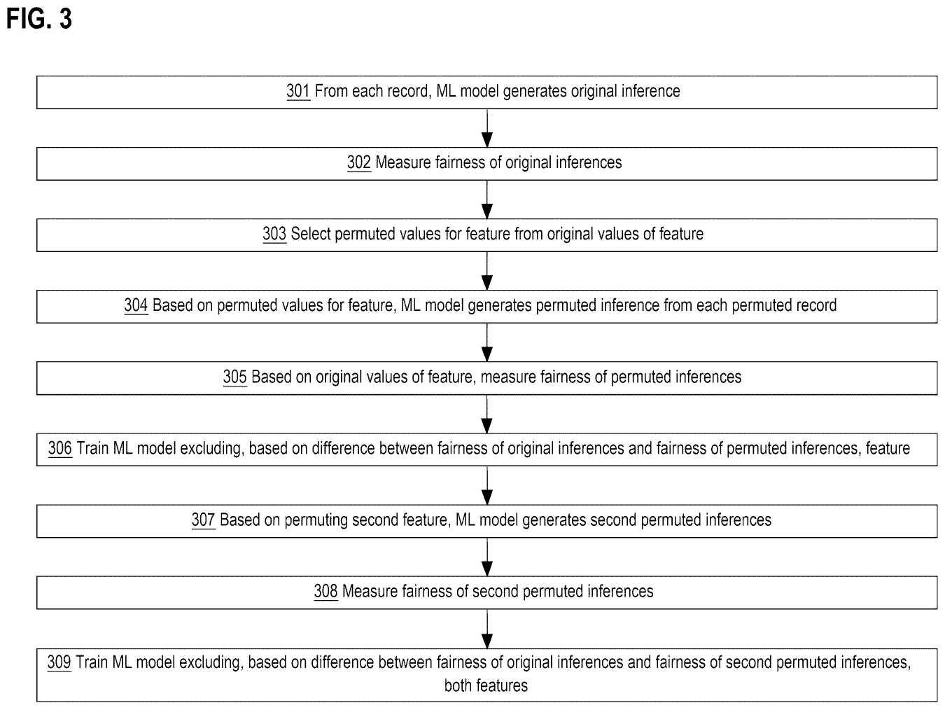

FIG. 3 is a flow diagram that depicts an example process that computer 100 may perform to interactively select some of features A-C to increase fairness of machine learning (ML) model 130 based on fairness impact measurement for sensitive feature A that can be permuted.

From each original record Y0-Z0, ML model 130 generates a respective one of original inferences IY0-IZ0 in step 301 as discussed earlier herein.

Step 302 measures fairness and accuracy of ML model 130 for original records 121. Step 302 measures fairness and accuracy of original inferences IY0-IZ0 as a group, not as individual inferences.

Steps 301-302 establish validation scores A0 and F0 as a baseline for comparison with validation scores of many permuted datasets such as 122-123 that could be generated. Steps 303-306 provide an example scenario in which dataset permuted A 122 is generated by permuting sensitive feature A which, in the state of the art, prevents fairness measurement. For example, sensitive feature A may be race or gender.

Step 303 randomly selects (i.e. not randomly generates) permuted values for sensitive feature A from original values AY-AZ. For example when generating permuted record YA that is an imperfect copy of original record Y0, step 303 may randomly select other original record Z0 that has value AZ that may provide the value of sensitive feature A in permuted record YA. Permutation by step 303 does not modify original records 121 that may be immutable.

Based on permuted values for sensitive feature A, ML model 130 generates permuted inferences IYA-IZA respectively from permuted records YA-ZA in dataset permuted A 122 in step 304. Step 305 uses inferences IYA-IZA to measure validation scores AA and FA. Although somewhat similar validation scoring step 302 uses only a single dataset that is original records 121, step 305 instead uses two datasets 121-122 in a novel way. Accuracy AA is measured using only a single dataset that is dataset permuted A 122. However, novel measurement of fairness FA uses two datasets 121-122 as follows.

Above step 304 generated inferences IYA-IZA using only a single dataset that is dataset permuted A 122. Step 305 measures fairness FA based on inferences IYA-IZA and original records 121, even though inferences IYA-IZA were generated from dataset 122 instead of 121.

Discussed later herein is interactive and default feature selection in various scenarios. Automatic measurement of validation impacts 170 and (e.g. interactive) feature selection occur between steps 305-306. Each of feature impacts AVA and AVE in validation impacts 170 is a measured difference between a validation score for original records 121 and a corresponding score for dataset permuted A 122 as discussed earlier herein.

In one scenario for sensitive feature A, accuracy impact AVA is near zero, which indicates that sensitive feature A has little effect on accuracy of ML model 130. In that case, if fairness impact AVF is negative and has significant magnitude then, as discussed later herein, sensitive feature A should be deselected (i.e. excluded) by feature selection. Step 306 retrains ML model 130 excluding, based on a difference (i.e. fairness impact AVF) between fairness A0 of original inferences IY0-IZ0 and fairness FA of permuted inferences IYA-IZA, sensitive feature A.

Above steps 303-306 provide a first example scenario that increases fairness by excluding sensitive feature A that identifies a protected group. The following second example scenario entails steps 307-309 that increase fairness by excluding feature C because feature C, which is not a sensitive feature, is correlated with sensitive feature A.

In preparation for step 307, dataset permuted C 123 is generated in the same way as above permutation step 303, except that preparation for step 307 permutes feature C instead of sensitive feature A. In step 307, ML model 130 generates permuted inferences IYC-IZC in the same way as above inference step 304, except that step 307 inferences from permuted dataset 123 instead of 122.

Step 308 measures fairness CVF of permuted inferences IYC-IZC. Unlike above step 305 that specially measures fairness FA of sensitive feature A, step 308 instead measures fairness FC of non-sensitive feature C in the same way as above step 302, except that step 308 measures fairness based on components 123, AC, and FC instead of components 121, A0, and F0. Thus, fairness scores F0 and FC are each measured using only a single dataset that is a respective one of datasets 121 and 123. However as discussed above, fairness FA for permuted sensitive feature A is instead measured using two datasets 121-122.

Step 309 retrains ML model 130 to increase fairness in the same way as above retraining step 306, except that step 309 excludes non-sensitive feature C instead of or, as discussed later herein, in addition to excluding sensitive feature A. As discussed later herein, multiple features can be excluded in a same retraining to maximize fairness or to optimize a combination of fairness and accuracy.

### 4.0 Example Global Explanation with Scatterplot

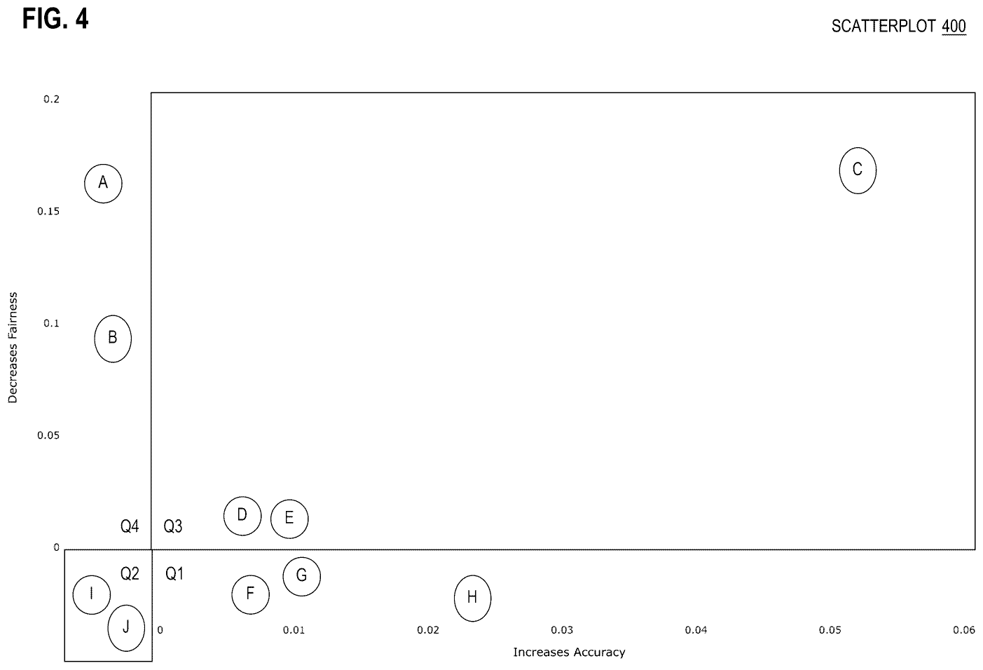

FIG. 4 depicts an example scatterplot 400 that computer 100 may generate and send or display, in an embodiment. In an embodiment, scatterplot 400 is part of a global explanation of ML model 130 that computer 100 generates and sends or displays. For example, ML model 130 might not be a self-explanatory model such as a random forest or a decision tree. In an embodiment, ML model 130 is opaque (i.e. black box).

Scatterplot 400 shows that fairness and accuracy of ML model 130 depends on features A-J that may or may not include features A-C in FIG. 1 or features A-J in FIG. 2. In other words, feature A may or may not be a different feature in each of FIGS. 1-2 and 4. The vertical axis of scatterplot 400 is bias impact that, as FIG. 4 says, “decreases fairness”. The horizontal axis is accuracy impact.

Each of features A-J is a respective circular point in scatterplot 400. Each of features A-J is in a respective one of quadrants Q1-Q4 in scatterplot 400. For example, features C-E are in quadrant Q3. The origin of scatterplot 400 is where corners of quadrants Q1-Q4 are adjacent, where bias impact and accuracy impact are both zero. If a feature were at the origin of scatterplot 400, then the feature is neutral with respect to influencing inferences by ML model 130. The further is a feature from the origin, the greater are the impact(s) of the feature.

In an embodiment, scatterplot 400 is three dimensional and its origin is a perspective vanishing point in the background. In that case, features D-G and I-J that are nearer to the origin are shown smaller in the background, and features A-C and H that are farther from the origin and shown larger in the foreground. In an embodiment, the depth effect of the origin is reversed and the origin and features D-G and I-J are instead in the foreground, and features A-C and H are in the background.

Most features have little impact on bias/fairness, which is why features D-J are near the origin of the vertical axis. Most features increase accuracy at least a little, which is why features C-H are in quadrants Q1 and Q3 that are to the right of the origin. Herein, each of quadrants Q1-Q4 is distinctly specialized as follows.

Features F-H in quadrant Q1 are perfect training features because they increase the model's accuracy without increasing bias. Herein, a perfect feature may be referred to as an ideal feature. By default, feature selection includes all perfect features. In an embodiment that displays scatterplot 400, a feature's inclusion or exclusion can be interactively adjusted, which does not change the feature's location in scatterplot 400 but may, for example, automatically change which color is the feature's point. For example, only excluded features may be gray.

Features A-B in quadrant Q4 are avoidable training features because they increase the model's bias without increasing accuracy. Herein, an avoidable feature may be referred to as a problematic feature. By default, feature selection excludes all avoidable features, which can be interactively adjusted as discussed above.

Features I-J in quadrant Q2 are neutral training features because they are near the origin of scatterplot 400 which, as discussed above, has no or almost no impact on both of fairness and accuracy. By default, feature selection includes all neutral features, which can be interactively adjusted. In the shown embodiment, quadrant Q2 is the smallest. In the shown embodiment, each of quadrants Q1-Q4 has a distinct respective size.

Features C-E in quadrant Q3 are dilemmatic training features because they increase both of bias and accuracy. Each dilemmatic feature has a respective tradeoff between fairness and accuracy. Inclusion or exclusion of dilemmatic features in feature selection may be by default or interactively adjusted.

After default and/or interactive feature selection, ML model 130 is retrained from scratch (e.g. internal parameters reset) with a training corpus (e.g. not the validation corpus). Retraining is not based on features excluded by feature selection. After retraining, ML model 130 is revalidated, which means that components 140, 150, and 170 are recalculated. For example if avoidable feature A is excluded, then fairness F0 of original records 121 may beneficially increase. In one scenario, features are interactively excluded (and training repeated) until a desired fairness and/or desired accuracy are exceeded.

In the following example embodiment, dilemmatic features are included by default. Interactive exclusion of features occurs sequentially by interactively excluding one feature after another, and ML model 130 is retrained after each feature exclusion. Each retraining generates and uses its own distinct version of datasets 120 that has its own distinct set of included features. For example, the sequence of re-trainings may be based on a non-monotonically shrinking set of included features of original records 121.

In an embodiment, all included features in all quadrants Q1-Q4 are collectively treated as a single cluster of points (i.e. features), and scatterplot 400 has an additional marker (not shown) that indicates the center of the cluster, which indicates overall fairness and overall accuracy of ML model 130 as more or less an average of fairness and accuracy scores of all included features. Interactive feature selection and retraining may occur until desired fairness or accuracy of ML model 130 is exceeded.

### 5.0 Second Example Interactive Feature Selection Process

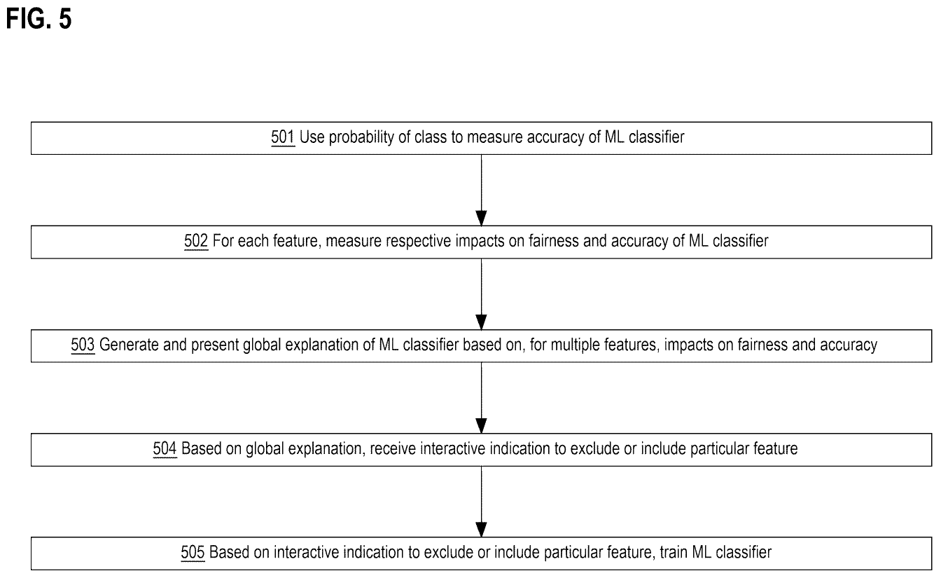

FIG. 5 is a flow diagram that depicts an example process that computer 100 may perform to generate and present a global explanation of machine learning (ML) model 130 that facilitates interactive selection of some of features A-C to increase fairness of machine learning (ML) model 130 based on fairness impact measurement for sensitive feature A that can be permuted. FIG. 5 is discussed with respect to FIGS. 1 and 4.

As discussed for FIG. 4, feature selection and retraining may occur in iterations (i.e. sequential repetitions) that entail interactive and automatic activities, and a decision to cease or continue iterating may be interactive. Also as discussed earlier herein, a first iteration may entail measurement of validation scores A0 and F0 with ML model 130 initially trained including all features A-C. The process of FIG. 5 may be repeated each iteration, including the first one. In other words, zero or more features may already be excluded when the process of FIG. 5 occurs.

In this example, ML model 130 is a classifier that may be a binary classifier that has only two classes or a multiclass classifier that has three or more classes. Herein, two classes is not multiclass because a binary classifier explicitly infers only one probability for one class, and the probability of the other class is implied. In other words, only multiclass classification may generate an inference that expressly contains multiple probabilities. Although this example demonstratively uses a classifier, only accuracy measurement step 501 entails a classifier. In an embodiment, ML model 130 is not a classifier and may, for example, be a regression, and step 501 instead measures the validation accuracy of the regression. Remaining steps 502-504 are sufficiently generalized to use any kind of ML model 130. Steps 502-504 may use the validation accuracy but do not care how accuracy was measured (by step 501). Thus, the process of FIG. 5 demonstrates a classifier but does not require that ML 130 be a classifier.

Step 501 uses a probability (i.e. inferred by the classifier that is ML model 130) of a class to measure accuracy of ML model 130. For example, step 501 may use log loss or AUC ROC that require raw (i.e. not postprocessed) inferred probabilities, and herein inferred probabilities are not postprocessed. Probability postprocessing is incompatible with log loss and AUC ROC that require raw probabilities, which may be problematic in the state of the art but not herein.

In an embodiment, each of inferences IY0-IZ0, IYA-IZA, and IYC-IZC contains a respective inferred probability of each of classes A-C. Step 501 may use inferred class probabilities to measure any one of accuracy scores A0, AA, or AC. For example if feature A already is excluded, then step 501 may measure accuracy score A0 or AC but not AA.

For each permuted (i.e. included) feature, step 502 measures respective impacts on fairness and accuracy of ML model 130. For example if feature A already is excluded, then step 502 may measure feature impacts CVA and CVF but not AVA and AVF.

Step 503 generates and presents (e.g. displays or emails) a global explanation of ML model 130 based on respective impacts on fairness and accuracy of multiple features such as included and/or excluded features such as some or all features A-J in FIG. 4. For example, step 503 may generate a global explanation that contains scatterplot 400 that may be interactive as discussed for FIG. 4.

Based on the global explanation, step 504 receives an interactive indication to exclude or include a particular feature. For example, a user may manipulate a graphical interface to toggle one or more features from included to excluded or vice versa as discussed for FIG. 4. In an embodiment, step 504 entails direct manipulation of a component of scatterplot 400 such as any feature that is displayed in scatterplot 400 as shown in FIG. 4. For example, clicking on a feature in scatterplot 400 may cause a popup (i.e. context) menu to appear, and interacting with the menu may be the interactive indication of step 504. In an embodiment, step 504 instead entails indirect manipulation. For example, a panel (not shown in FIG. 4) may be displayed adjacent to scatterplot 400, and manipulation of widget(s) (i.e. interactive controls) in the panel may be the interactive indication of step 504.

Based on the interactive indication to exclude or include the particular feature, step 505 (re-)trains ML model 130 as discussed earlier herein. After training, ML model 130 may be deployed into a production environment, or the process of FIG. 5 may be repeated for further feature (de-)selection until an optimal tradeoff between fairness and accuracy is achieved.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

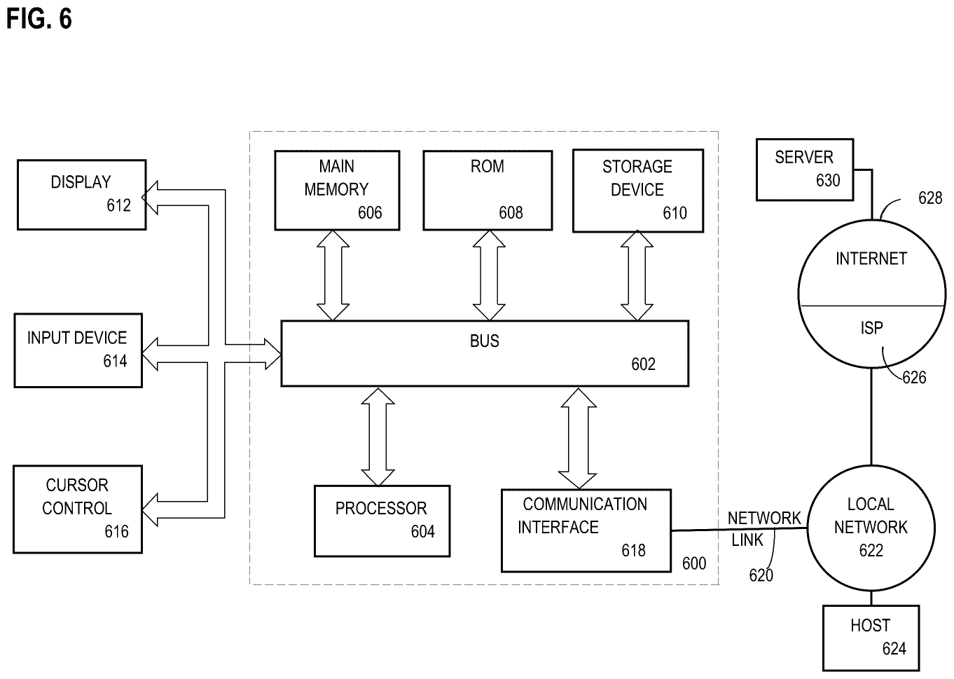

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### Software Overview

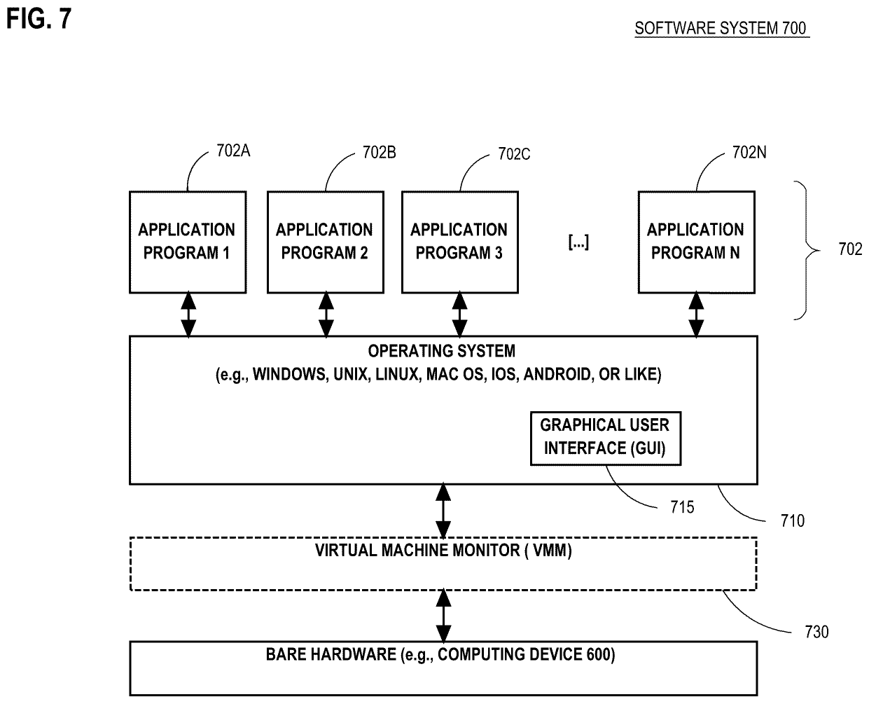

FIG. 7 is a block diagram of a basic software system 700 that may be employed for controlling the operation of computing system 600. Software system 700 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 700 is provided for directing the operation of computing system 600. Software system 700, which may be stored in system memory (RAM) 606 and on fixed storage (e.g., hard disk or flash memory) 610, includes a kernel or operating system (OS) 710.

The OS 710 manages low-level aspects of computer operation, including managing execution of processes, memory allocation, file input and output (I/O), and device I/O. One or more application programs, represented as 702A, 702B, 702C . . . 702N, may be “loaded” (e.g., transferred from fixed storage 610 into memory 606) for execution by the system 700. The applications or other software intended for use on computer system 600 may also be stored as a set of downloadable computer-executable instructions, for example, for downloading and installation from an Internet location (e.g., a Web server, an app store, or other online service).

Software system 700 includes a graphical user interface (GUI) 715, for receiving user commands and data in a graphical (e.g., “point-and-click” or “touch gesture”) fashion. These inputs, in turn, may be acted upon by the system 700 in accordance with instructions from operating system 710 and/or application(s) 702. The GUI 715 also serves to display the results of operation from the OS 710 and application(s) 702, whereupon the user may supply additional inputs or terminate the session (e.g., log off).

OS 710 can execute directly on the bare hardware 720 (e.g., processor(s) 604) of computer system 600. Alternatively, a hypervisor or virtual machine monitor (VMM) 730 may be interposed between the bare hardware 720 and the OS 710. In this configuration, VMM 730 acts as a software “cushion” or virtualization layer between the OS 710 and the bare hardware 720 of the computer system 600.

VMM 730 instantiates and runs one or more virtual machine instances (“guest machines”). Each guest machine comprises a “guest” operating system, such as OS 710, and one or more applications, such as application(s) 702, designed to execute on the guest operating system. The VMM 730 presents the guest operating systems with a virtual operating platform and manages the execution of the guest operating systems.

In some instances, the VMM 730 may allow a guest operating system to run as if it is running on the bare hardware 720 of computer system 600 directly. In these instances, the same version of the guest operating system configured to execute on the bare hardware 720 directly may also execute on VMM 730 without modification or reconfiguration. In other words, VMM 730 may provide full hardware and CPU virtualization to a guest operating system in some instances.

In other instances, a guest operating system may be specially designed or configured to execute on VMM 730 for efficiency. In these instances, the guest operating system is “aware” that it executes on a virtual machine monitor. In other words, VMM 730 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system. CLOUD COMPUTING

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depend on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicted output. An error or variance between the predicted output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria are met.

In a software implementation, when a machine learning model is referred to as receiving an input, being executed, and/or generating an output or prediction, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of the best breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neurons.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as a vector. Training data comprises multiple inputs, each being referred to as a sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Fewer neurons means fewer activation values need be computed, and/or fewer derivative values need be computed during training.

Properties of matrices used to implement a neural network correspond to neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in a matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that are not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix-based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depend on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occur as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2(1):1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
generating, from each record in a plurality of records, a respective original inference of a plurality of original inferences;
measuring, based on the plurality of original inferences, a fairness of the plurality of original inferences;
selecting, after said generating, a plurality of permuted values for a feature from a plurality of original values of the feature;
generating, based on said plurality of permuted values for the feature, from each record in the plurality of records, a respective permuted inference of a plurality of permuted inferences;
measuring, based on said plurality of original values of the feature, a fairness of said plurality of permuted inferences; and
training a machine learning model with the plurality of records excluding, based on a difference between the fairness of the plurality of original inferences and the fairness of the plurality of permuted inferences, the feature.

2. The method of claim 1 wherein:
said feature is a first feature;
said plurality of permuted inferences are first permuted inferences;
the method further comprises:
generating, based on permuting a second feature, second permuted inferences from the plurality of records;
measuring, based on said permuting the second feature, a fairness of said second permuted inferences.

3. The method of claim 2 further comprising training the machine learning model excluding, based on a difference between the fairness of the plurality of original inferences and the fairness of the second permuted inferences, the second feature.

4. The method of claim 3 wherein said training excluding the first feature and said training excluding the second feature are a same training.

5. The method of claim 3 wherein:
said permuting the second feature is a first permuting the second feature;
the method further comprises before said training excluding the first feature, generating third permuted inferences from the plurality of records based on a second permuting the second feature;
said training excluding the first feature includes, based on a fairness of said third permuted inferences, the second feature;
said training excluding the second feature excludes the first feature.

6. The method of claim 1 wherein:
said generating said plurality of original inferences comprises training the machine learning model including the feature;
the method further comprises measuring a fairness of inferences from the plurality of records based on said training excluding the feature;
said fairness of inferences based on said training excluding the feature is higher than said fairness of said plurality of original inferences.

7. The method of claim 1 wherein the machine learning model does not comprise a random forest or a decision tree.

8. A method comprising:
measuring for each feature of a plurality of features:
a respective impact on fairness of a machine learning model, and
a respective impact on accuracy of the machine learning model;
generating and presenting a global explanation of a machine learning model based on, for multiple features of the plurality of features, said impacts on fairness and said impacts on accuracy;
receiving, based on the global explanation of a machine learning model, an interactive indication to exclude or include a particular feature of the plurality of features; and
training the machine learning model based on the interactive indication to exclude or include the particular feature of the plurality of features.

9. The method of claim 8 wherein:
said multiple features of the plurality of features contains a second feature;
the global explanation contains at least one selected from a group consisting of:
an indication of whether the second feature increases or decreases fairness of the machine learning model, and
an indication of whether the second feature increases or decreases accuracy of the machine learning model.

10. The method of claim 8 wherein:
said multiple features of the plurality of features contains a second feature;
the global explanation contains a scatterplot that contains, based on said impacts on fairness and said impacts on accuracy, a respective point for each feature of the multiple features.

11. The method of claim 10 wherein the scatterplot contains:
a first quadrant that contains said points of the multiple features that increase fairness of the machine learning model and increase accuracy of the machine learning model,
a second quadrant that contains said points of the multiple features that increase fairness of the machine learning model and decrease accuracy of the machine learning model,
a third quadrant that contains said points of the multiple features that decrease fairness of the machine learning model and increase accuracy of the machine learning model, and
a fourth quadrant that contains said points of the multiple features that decrease fairness of the machine learning model and decrease accuracy of the machine learning model.

12. The method of claim 11 wherein the second quadrant is a smallest quadrant in the scatterplot.

13. The method of claim 10 wherein the scatterplot contains four quadrants that have distinct respective sizes.

14. The method of claim 8 wherein:
the machine learning model is a classifier that infers a probability of a class;
the method further comprises using the probability of the class to measure said accuracy of the machine learning model.

15. One or more non-transitory computer-readable media storing instructions that, when executed by one or more processors, cause:
generating, from each record in a plurality of records, a respective original inference of a plurality of original inferences;
measuring, based on the plurality of original inferences, a fairness of the plurality of original inferences;
selecting, after said generating, a plurality of permuted values for a feature from a plurality of original values of the feature;
generating, based on said plurality of permuted values for the feature, from each record in the plurality of records, a respective permuted inference of a plurality of permuted inferences;
measuring, based on said plurality of original values of the feature, a fairness of said plurality of permuted inferences; and
training a machine learning model with the plurality of records excluding, based on a difference between the fairness of the plurality of original inferences and the fairness of the plurality of permuted inferences, the feature.

16. The one or more non-transitory computer-readable media of claim 15 wherein:
said feature is a first feature;
said plurality of permuted inferences are first permuted inferences;
the instructions further cause:
generating, based on permuting a second feature, second permuted inferences from the plurality of records;
measuring, based on said permuting the second feature, a fairness of said second permuted inferences.

17. The one or more non-transitory computer-readable media of claim 15 wherein:
said generating said plurality of original inferences comprises training the machine learning model including the feature;
the instructions further cause measuring a fairness of inferences from the plurality of records based on said training excluding the feature;
said fairness of inferences based on said training excluding the feature is higher than said fairness of said plurality of original inferences.

18. One or more non-transitory computer-readable media storing instructions that, when executed by one or more processors, cause:
measuring for each feature of a plurality of features:
a respective impact on fairness of a machine learning model, and
a respective impact on accuracy of the machine learning model;
generating and presenting a global explanation of a machine learning model based on, for multiple features of the plurality of features, said impacts on fairness and said impacts on accuracy;
receiving, based on the global explanation of a machine learning model, an interactive indication to exclude or include a particular feature of the plurality of features; and
training the machine learning model based on the interactive indication to exclude or include the particular feature of the plurality of features.

19. The one or more non-transitory computer-readable media of claim 18 wherein:
said multiple features of the plurality of features contains a second feature;
the global explanation contains at least one selected from a group consisting of:
an indication of whether the second feature increases or decreases fairness of the machine learning model, and
an indication of whether the second feature increases or decreases accuracy of the machine learning model.

20. The one or more non-transitory computer-readable media of claim 18 wherein:
said multiple features of the plurality of features contains a second feature;
the global explanation contains a scatterplot that contains, based on said impacts on fairness and said impacts on accuracy, a respective point for each feature of the multiple features.
